(19) United States
(12) Patent Application Publication
(10) Pub. No.: US 2004/0139300 A1
(43) Pub. Date: Jul. 15, 2004

(54) Result forwarding in a superscalar processor

(75) Inventors: Fadi Busaba, Poughkeepsie, NY (US); Klaus J. Getzlaff, Schoenaich (DE); Bruce C. Giamei, Poughkeepsie, NY (US); Christopher A. Krygowski, Lagrangeville, NY (US); Timothy J. Slegel, Staatsburg, NY (US)

Correspondence Address: Lynn L. Augspurger, IBM Corporation, P386, 2455 South Road, Poughkeepsie, NY, 12601, US

(73) Assignee: International Business Machines Corporation, Armonk, NY

(21) Appl. No.: 10/341,995

(22) Filed: Jan. 14, 2003

(51) Int. Cl. G06F 9/30

(52) U.S. Cl. 712/218

(57) ABSTRACT

A method and mechanism for improving Instruction Level Parallelism (ILP) of a program and eventually improving Instructions per cycle (IPC) allows dependent instructions to be grouped and dispatched simultaneously by forwarding the oldest instruction, or source instruction, result to the other dependent instructions result buses or registers thus bypassing the dependent instruction execution stage. A source instruction that performs arithmetic, logical or rotate/shift type operation on operands and updates a GR with the computed result. A load type dependent or target instruction loading a GR value into a GR will then select the forwarded result of the source instruction to its write bus for the GR update. Another target instruction of a store type stores a memory data from a GR data. The result of source instruction is also used by the dependent instruction to update storage. The mechanism allows also the dependent instruction to be a load type that loads a GR data into a Control Register (CR). The result data of the source instruction is then selected by the target instruction for the CR update.

### FIELD OF THE INVENTION

This invention is related to computers and computer systems and to the instruction-level parallelism and in particular to dependent instructions that can be grouped and issued together through a superscalar processor.

Trademarks: IBM® is a registered trademark of International Business Machines Corporation, Armonk, N.Y., U.S.A. Other names may be registered trademarks or product names of International Business Machines Corporation or other companies.

### BACKGROUND

The efficiency and performance of a processor is measured in the number of instructions executed per cycle (IPC). In a superscalar processor, instructions of the same or different types are executed in parallel in multiple execution units. The decoder feeds an instruction queue from which the maximum allowable number of instructions are issued per cycle to the available execution units. This is called the grouping of the instructions. The average number of instructions in a group, called size, is dependent on the degree of instruction-level parallelism (ILP) that exists in a program. Data dependencies among instructions usually limit ILP and result, in some cases, in a smaller instruction group size. If two instructions are dependent, they cannot be grouped together since the result of the first (oldest) instruction is needed before the second instruction can be executed resulting to serial execution. Depending on the pipeline depth and structure, data dependencies among instructions will not only reduce the group size but also may result in “gaps”, sometimes called “stalls” in the flow of instructions in the pipeline. Most processors have bypasses in their data flow to feed execution results immediately back to the operand input registers to reduce stalls. In the best case this allows a “back to back” execution without any cycle delays of data dependent instructions. Others support out of order execution of instructions, so that newer, independent instructions can be executed in these gaps. Out of order execution is a very costly solution in area, power consumption, etc., and one where the performance gain is limited by other effects, like misprediction branches and increase in cycle time.

### SUMMARY OF THE INVENTION

Our invention provides a method that allows the grouping and hence of dependent instructions in a superscalar processor. The dependent instruction(s) is not executed after the first instruction, it is rather executed together with it. The grouping when dependent instructions are dispatched together for execution is made possible due to the “result forwarding”. The result of the source instruction (architecturally older) is forwarded as it is being written to the target result register of the dependent instruction(s) (newer instruction(s)) thus bypassing the execution stage of the target instruction.

In accordance with the invention, ILP is improved in the presence of FXU dependencies by providing a mechanism for result forwarding from one FXU pipe to the other.

In accordance with our invention, instruction grouping can flow through the FXU. Each of the groups 1 and 2 consists of three instructions issued to pipes B, X and Y. Group 3 consists only of two instructions with pipe Y being empty and this, as discussed earlier, may be due to instruction dependencies between groups 3 and 4. This gap empty slot may be filled by result forwarding.

These and other improvements are set forth in the following detailed description. For a better understanding of the invention with advantages and features, refer to the description and to the drawings.

### DESCRIPTION OF THE DRAWINGS

FIG. 1 illustrates the pipeline sequence for a single instruction.

FIG. 2 illustrates the FXU Instruction Execution Pipeline Timing.

FIG. 3 illustrates an example of a result forwarding when the forwarded result is used by the target instruction for GR update.

FIG. 4 illustrates an example of a result forwarding when the forwarded result is used by the target instruction for storage or CR update.

Our detailed description explains the preferred embodiments of our invention, together with advantages and features, by way of example with reference to the drawings.

### DETAILED DESCRIPTION OF THE INVENTION

In accordance with our invention we have provided a result forwarding mechanism for the superscalar (multiple execution pipes) in-order micro-architecture of our preferred embodiment, as illustrated in the Figures.

Result forwarding is used, when the first instruction and (or) oldest instruction, performs any computation such as arithmetic, logical, shift/rotate or load type operation on instruction operands and updated a GR with the new compyted result, and a subsequent instruction (as a target instruction), needs the first instruction computed result to perform a register load, store or a control register write on that result. The target instruction may also set in parallel a condition code. Since the cycle time or frequency of the microprocessor is often limited to how fast the Fixed Point Unit can compute an addition during E1-stage and bypass it back to the input registers, the target instruction of a result forwarding will not be allowed to do any computation of the source instruction result. The source and target instructions may have their results update storage, GR-data or a control register. Rather than waiting for the execution of the first instruction and writing the result back, the respective result data is also routed directly to the result registers of next instruction(s).

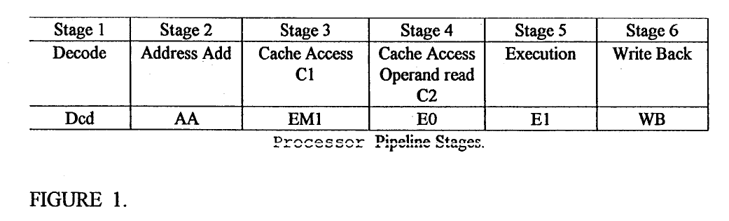

Result forwarding is not limited to any processor micro-architecture and is we feel best suited for superscalar (multiple execution pipes) in-order micro-architecture. The following description is of a computer system pipeline where our operand forwarding mechanism and method is applied. The basic pipeline sequence for a single instruction is shown in FIG. 1A. The pipeline does not show the instruction fetch from Instruction Cache (I-Cache). The decode stage (DcD) is when the instruction is being decoded, and the B and X registers are being read to generate the memory address for the operand fetch. During the Address Add (AA) cycle, the displacement and contents of the B and X registers are added to form the memory address. It takes two cycles to access the Data cache (D-cache) and transfer the data back to the execution unit (C1 and C2 stages). Also, during C2 cycle, the register operands are read from the register file and stored in working registers preparing for execution. The E1 stage is the execution stage and WB stage is when the result is written back to register file, stored away in the D-cache, or update a control register. There are two parallel decode pipes allowing two instructions to be decoded in any given cycle. Decoded instructions are stored in instruction queues waiting to be grouped and issued. The instructions groupings are formed in the AA cycle and are issued during the EM1 cycle, which overlaps with the C1 cycle). There are four parallel execution units in the Fixed Point Unit named B, X, Y and Z. Pipe B is a control only pipe used for the branch instructions. The X and Y pipes are similar pipes capable of executing most of the logical and arithmetic instructions. Pipe Z is the multi-cycle pipe used mainly for decimal instructions and for integer multiply instructions. The IBM z-Series current micro-architecture allows the issue of up to three instructions; one branch instruction issued to B-pipe, and two Fixed Point Instructions issued to pipes X and Y. Multi-cycle instructions are issued alone. Data dependencies detection and data forwarding are needed for AA and E1 cycles. Dependencies for address generation in AA cycle are often referred to as Address-Generation Interlock (AGI), whereas dependencies in E1 stage is referred to as FXU dependencies.

In order to have no impact on cycle time of the processor, the result forwarding is limited to a certain group of instructions. For a given two instructions i and j of a group, the result of instruction i is forwarded to the result register of instruction j if instruction i is architecturally older than instruction j, instruction j is a load or store type, instruction j is dependent on the result of instruction i, and the result of instruction j is easily extracted from the operand. Easily extracted means that no arithmetic, logical or shift type operation is required on the operand to calculate the result. Although instruction j is limited to load or store type, these instructions are very frequent in many workloads and result forwarding gives a significant IPC improvement with little extra hardware.

In the following, some detailed examples are given.

The first example describes a result forwarding case when the target result updates a GR. There are two instructions in this example. The first or source instruction performs an arithmetic operation using R1 and R2 and writing the result back to R1, and the next or target instruction, LTR, loads R3 from R1.

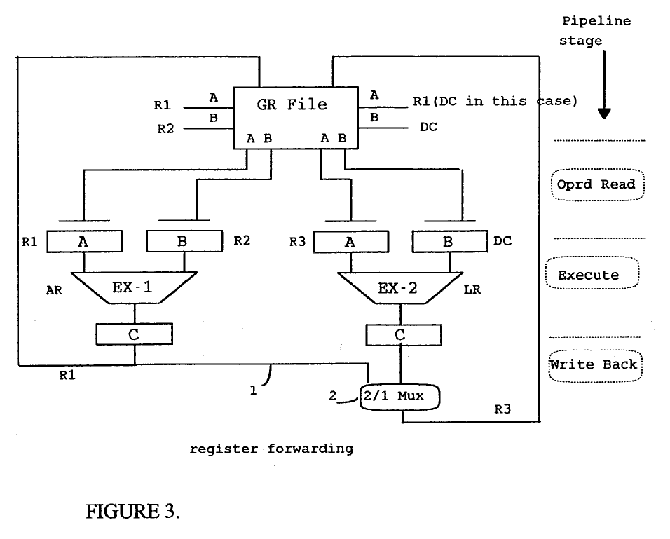

FIG. 3 shows the result of the source instruction, executed on pipe EX-1, being forwarded using bus (1) to the target instruction on EX-2 and mulyiplexed (2) with the result of the target instruction. The multiplexer (2) can be either placed before or after the C-register of EX-2 FXU pipe. As a result of this result forwarding, the same result computed on EX-1 can now be used to update GR-RL for source instruction and GR-R3 for target instruction simultaneously.

Source Instruction AR R1, R2 (GR-RL <- GR-R1+GR-R2)

Target Instruction LTR R3, R1 (GR-R3 <- GR-R1)

The issue logic ignores the read after write conflict with R1, because the LR instruction can get its data forwarded from the result of AR instruction. It groups both instructions together and sets the multiplexer (2) selects to ingate the EX-1 result instead of EX-2 result. The read ports and execution control of the LR instruction are not needed. Both instructions update the condition code but priority is given to the newest instruction, which is LTR in this case. There are no additional hardware control requirements needed for the condition code setting since the FXU can handle the case when many simultaneous instructions update the condition code.

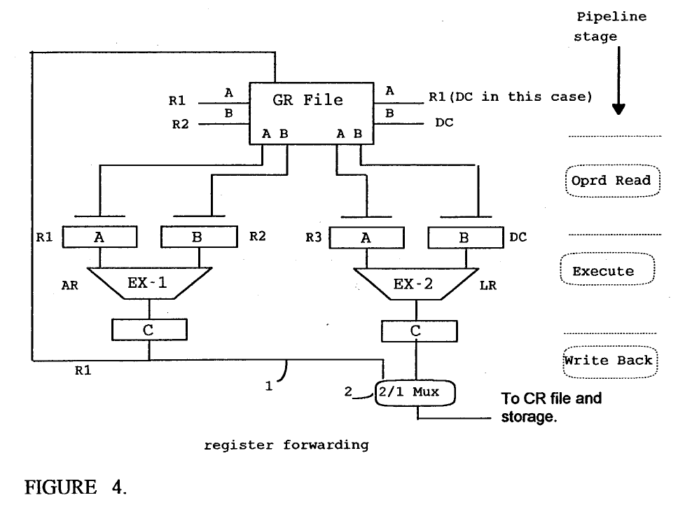

The second example covers the case when the target instruction updates a control register as shown in FIG. 4. A source instruction updates a GR, while a second or target instruction reads the same GR and updates a control register, CR. The control logic in this example will be the same as in first example except for the register write address of the target instruction.

Source Instruction AR R1, R2 (GR-RL <- GR-RL+GR-R2)

Target Instruction WSR CR1, R1 (CR1 <- GR-RL)

As in the first example, the issue logic ignores the read after write conflict with R1, because the WSR instruction gets its data from the result of AR instruction thus bypassing its execution stage, EX-2. The issue logic groups both instructions together and sets the multiplexer (2) selects to ingate the EX-1 result instead of EX-2 result. Again, there are no additional hardware requirements for this type of result forwarding.

The third example describes a result forwarding case when the target result updates storage as shown in FIG. 4. The first instruction is an add instruction, AR, performs an arithmetic operation using R1 and R2 and writing the result back to R1. The next and dependent instruction stores the contents of R1 to storage.

AR R1, R2

ST R1, Storage

Again, the issue logic ignores the read after write conflict with R1, because the ST instruction can get its result forwarded from the result of AR instruction. It groups both instructions together and, as in the first example, sets the control of the multiplexer 2 to select the result of EX-1 (result of AR). In this case, the result of AR is used to update the contents of GR for AR instruction and storage for the ST instruction simultaneously. The same forwarded result bus and multiplexer that are used in the previous examples are also used in this case and no extra hardware is required.

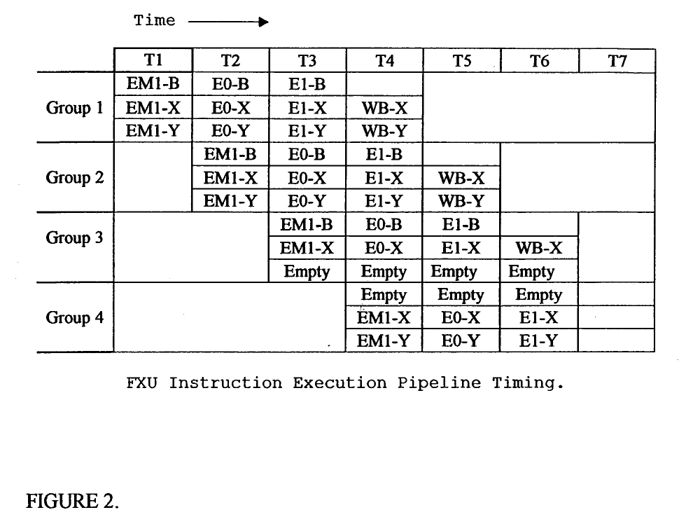

As has been stated, FIG. 2 illustrates the FXU Instruction Execution Pipeline Timing. With such timing ILP is improved in the presence of FXU dependencies by providing a mechanism for result forwarding from one FXU pipe to the other.

Instruction grouping can flow through the FXU. Each of the groups 1 and 2 consists of three instructions issued to pipes B, X and Y. Group 3 consists only of two instructions with pipe Y being empty and this, as discussed earlier, may be due to instruction dependencies between groups 3 and 4. This gap empty slot may be filled by result forwarding.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A computer system mechanism of improving Instruction Level Parallelism (ILP) of a program, comprising:
a result forwarding mechanism for a superscalar (multiple execution pipes) in-order micro-architected computer system having multiple execution pipes and providing result forwarding of an instruction when a first and oldest source instruction computes a result and loads it into a register, and a subsequent instruction reads the same updated register, and rather than waiting for the execution of the first source instruction and writing the result back, the result data of the source instruction are routed directly to an output result bus or result register of subsequent instructions in said execution pipes.

2. The computer system mechanism according to claim 1 wherein said subsequent instruction is a target instruction and said target instruction sets in parallel a condition code.

3. The computer system mechanism according to claim 1 wherein said subsequent instruction is a target instruction and said target instruction sets its result register or output result bus from the result of the said source instruction.

4. The computer system mechanism according to claim 1 wherein said result being forwarded to the target instructions that update storage, general registers, GR's, or control registers, CR's.

5. The computer system mechanism according to claim 1 wherein said mechanism allows dependent instructions to be grouped and dispatched simultaneously by forwarding the first and oldest source instruction result to the result bus or register of other dependent instructions.

6. The computer system mechanism according to claim 4 wherein said the target instruction is a load type instruction loading a GR value into a general register (GR).

7. The computer system mechanism according to claim 5 wherein said dependent instructions will then select the forwarded result over their own result as their final result.

8. The computer system mechanism according to claim 1 wherein dependent instructions are grouped and dispatched simultaneously by forwarding the result of the said first and oldest instruction to the dependent instructions where they update memory contents (storage).

9. The computer system mechanism according to claim 1 wherein dependent instructions are grouped and dispatched simultaneously by forwarding the result of said source instruction to the dependent instructions that update Control Register (CR).
